(19) United States
(12) Patent Application Publication
(10) Pub. No.: US 2008/0141175 A1
(43) Pub. Date: Jun. 12, 2008

(54) System and Method For Mobile 3D Graphical Messaging

(76) Inventors: Lalit Sarna, Mountain View, CA (US); David M. Westwood, Palo Alto, CA (US); Connie Wong, Mercer Island, WA (US); Gregory L. Lutter, Palo Alto, CA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/577,577

(22) PCT Filed: Oct. 21, 2005
(86) PCT No.: PCT/US05/38059

§ 371 Date: Jul. 9, 2007

Related U.S. Application Data
(60) Provisional application No. 60/621,273, filed on Oct. 22, 2004.

(51) Int. Cl. G06F 3/048

(52) U.S. Cl. 715/848

(57) ABSTRACT

Mobile 3D graphical communication is provided in a communication network for wireless devices. A sender can create and customize a 3D graphical representation that will convey the sender's content, and then provide the animation for the 3D graphical representation locally on a sender device or have a remote server provide the animation. The server provides the animated 3D graphical representation to a recipient device so that the recipient device can render the animated 3D graphical for presentation of the sender's content. Transformation (including transcoding) techniques can be used, by the user devices and/or the server, to change the message (from text to audio, from 3D to 2D, etc., for example) to be consistent with animated 3D graphical presentation capabilities of the user devices and/or to match user preferences. Transformation can be performed prior to or during delivery of the content. The 3D graphical communication can also be used to provide content from a content provider to any user device whether wireless or hardwire, such as with a subscription service, or can be used to post animated 3D graphical content at a network location, such as a blog.

### CROSS REFERENCE TO RELATED APPLICATION

The present application claims the benefit of U.S. Provisional Patent Application Ser. No. 60/621,273, entitled “MOBILE 3D GRAPHICAL MESSAGING,” filed Oct. 22, 2004, assigned to the same assignee as the present application, and incorporated herein by reference in its entirety.

### TECHNICAL FIELD

The present disclosure generally relates to communication of graphical data over communications networks, and in particular but not exclusively, relates to communication of three-dimensional (3D) graphical data, such as for example messages, presentations, and the like for mobile wireless communication environments.

### BACKGROUND INFORMATION

Communication using wireless devices, such as cellular telephones, has greatly evolved over the years. Traditionally, wireless communications simply involved carrying out a live conversation between two wireless users (e.g., a “phone call”). Afterwards, technology improved to allow wireless users to create and send audio messages (e.g., voicemails) to one another.

However, with rapid improvements in technology and with the evolution of the Internet, a vast number of capabilities are now available to wireless users. For example, wireless devices are now available with capabilities comparable to traditional laptop personal computers (PCs) or other electronic devices, including Internet browsing, functional graphical displays, image capture (e.g., camera), email, improved user input mechanisms, application software programs, audio and video playback, and various other services, features, and capabilities. Moreover, wireless devices with such capabilities no longer encompass just cellular telephones, but also include PDAs, laptops, Blackberries, and other types of mobile wireless devices that can communicate with one another over a communication network.

Mobile messaging capability is one reason why wireless devices are popular to users. With mobile messaging, users can send messages to each other without necessarily having to speak to each other in real time (e.g., live voice communication). Traditional forms of mobile messaging can be divided into two main categories: audio (such as voice mail) or text (such as Short Message Service or SMS, or e-mail services). Multimedia Messaging Services (MMS) is a less common messaging technique that allows for the combination of audio, text, image and video media formats. As an example, instant messaging (IM) via wireless devices is an extremely popular form of communications among teenagers and other user groups that prefer to quickly and unobtrusively generate, send, and receive short messages, without necessarily having to compose a formal email or conduct a live audio conversation.

However, traditional audio and textual mobile messaging techniques are rather dull. Indeed, a simple audio or textual presentation has limits as to user appeal. For example, users (whether the sender or the recipient) may not be particularly excited about having to write/read email message—textual presentations do not readily capture and maintain a recipient's interest.

To enhance the user experience with mobile messaging, two-dimensional (2D) graphical communications have been used. For instance, users can accompany or replace traditional audio or text messages with graphics and video, such as through the use of MMS. As one example, wireless users can perform IM messaging using cartoon characters that represent each user. As another example, wireless users can exchange recorded video (e.g., video mail) with one another.

While such 2D graphical enhancements have improved the user experience, such 2D graphical enhancements are also rather dull and/or may be difficult to generate and playback. For example, video transmission and reception in a wireless environment is notoriously poor in many situations (due at least in part to channel conditions and/or wireless device capability limitations), and further does not provide the sender or receiver great capability and flexibility to finely control the presentation of the video. As another example, instant messaging using 2D cartoon representations provides a rather simplistic presentation that is limited in user appeal, both from the sender's and the recipient's point of view.

Wireless device manufacturers, service providers, content providers, and other entities need to be able to provide competitive products in order to be successful in their business. This success depends at least in part on the ability of their products and services to greatly enhance the user experience, thereby increasing user demand and popularity for their products. There is therefore a need to improve current mobile graphical messaging products and services.

### BRIEF SUMMARY OF THE INVENTION

According to one aspect, a method usable in a communication network is provided. The method includes obtaining an original message, obtaining a three-dimensional (3D) graphical representation, and determining whether a recipient device is suitable receive an animated 3D graphical message derived from the original message and from the 3D graphical representation. If the recipient device is determined to be suitable for the animated 3D graphical message, the method generates the animated 3D graphical message and delivers same to the recipient device. If the recipient device is determined to be unsuitable for the animated 3D graphical message, the method instead generates some other type of message that is derived from the original message and delivers same to the recipient device.

### BRIEF DESCRIPTION OF THE SEVERAL VIEWS OF THE DRAWINGS

Non-limiting and non-exhaustive embodiments are described with reference to the following drawings, wherein like reference numerals refer to like parts throughout the various views unless otherwise specified.

FIG. 1 is a block diagram of an embodiment of a system that can provide mobile 3D graphical messaging.

FIG. 2 is a flowchart of an embodiment of a method to create a 3D graphical message at a sender device.

FIG. 3 is a flowchart of an embodiment of a method at a server to provide messages, including animated 3D graphical messages, from the sender device to a recipient device.

FIG. 4 is a flowchart of an embodiment of a method to present a message, including animated 3D graphical messages, at the recipient device.

FIG. 5 is a flowchart of an embodiment to provide animated 3D graphical messages to subscribing user devices.

### DETAILED DESCRIPTION

In the following description, certain specific details are set forth in order to provide a thorough understanding of various embodiments. However, one skilled in the art will understand that the present systems and methods may be practiced without these details. In other instances, well-known structures, protocols, and other details have not been shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

As an overview, embodiments provide novel 3D graphical communication capabilities for mobile wireless device having connectivity to a communication network. Examples of the 3D graphical communications include, but are not limited to, messaging, posting content to network locations, communication of content from content providers to client devices, online games, and various other forms of communication that can have animated 3D graphical content. In one example and non-limiting embodiment, the 3D graphical messaging is in the form of user-customizable 3D graphical animations. As previously explained above, traditional forms of mobile messaging can be divided into two main categories: audio (e.g., voice mail) or text (e.g., SMS or e-mail services). An embodiment provides improvements in mobile messaging by adding animated 3D graphical representations that go well beyond capabilities of existing messaging techniques, which simply involve the combination of audio, text, image and video media formats, and for which 3D graphical representations have not been traditionally used/integrated. Another feature of an embodiment allows mobile devices to author and/or enhance these graphical messaging by using a 3D graphical messaging platform resident on the sender's mobile device and/or on a server, thereby providing customized 3D graphical messaging capabilities.

According to one embodiment, the animated 3D graphical message can be in the form of an animated 3D avatar of the user. In another embodiment, the animated 3D avatar can be that of some other person (not necessarily a user of a wireless device), and in fact can be an animated 3D avatar of a fictional person or any other creature that can be artistically customized and created by the user. In still other embodiments, the animated 3D graphical message need not even have any graphical representations of individuals or other beings at all. Animated 3D graphical messages can be provided to represent machines, background scenery, mythical worlds, or any other type of content that can be represented in the 3D world and that can be created and customized by the user. In still other embodiments, the animated 3D graphical message could comprise any suitable combination of 3D avatars, 3D scenery, and other 3D content.

It is appreciated that the above customization and animation are not limited to just 3D messaging. The customization and animation of 3D content can be applied for other applications where presentation would be enhanced by adding a 3D element, including but not limited to, posting content at a network location, playing games, presenting content for access by other users, providing services, and so forth. For the sake of simplicity of explanation, various embodiments will be described herein in the context of messaging, and again, it is understood that such description can be adapted as appropriate for applications that no not necessarily involve messaging.

Conventional forms of visual communications use formats that do not preserve the object nature of the captured natural video media. By preserving the object nature of video, an embodiment allows a user to personalize and interact with each of the object components of the video. The advantage of the 3D animation format is the ease of constructing a nearly unbounded set of personalized customizations simply by modifying the objects comprising the video—an impossibility (or extremely difficult for a user) for traditional video formats. For example, a user could rotate or change the texture of an image if that representation of that image maintained the 3D spatial coordinates of the objects represented in the image.

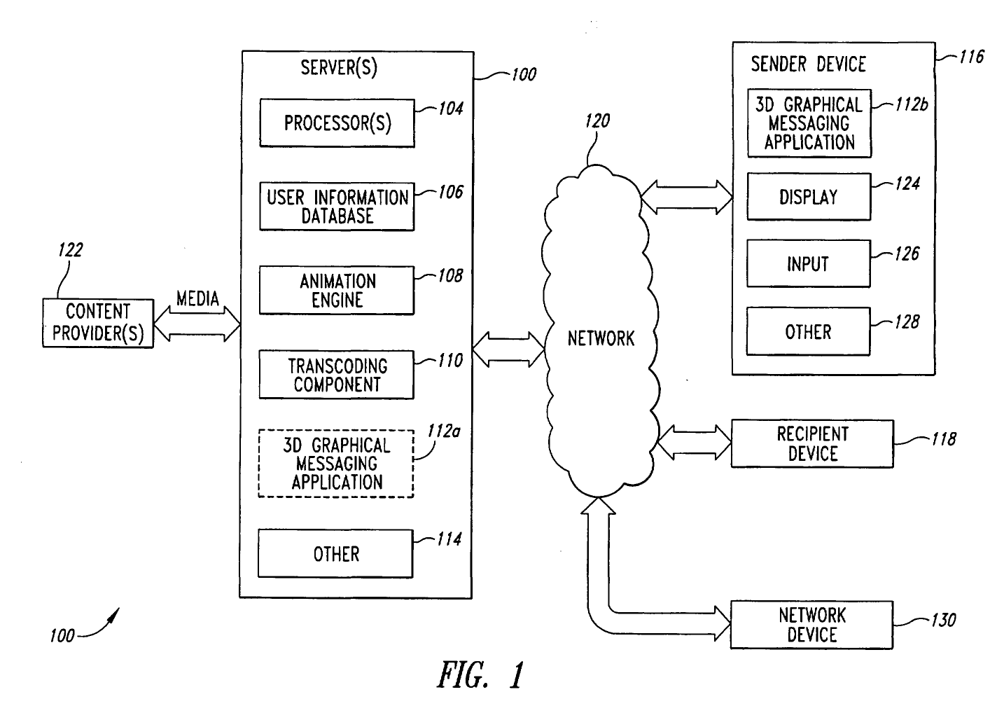

FIG. 1 is a block diagram of an embodiment of a system 100 that can be used to implement mobile 3D graphical communications, for example animated 3D graphical messaging and other forms of animated 3D graphical communication for wireless devices. For the sake of brevity and to avoid clutter, not every possible type of network device and/or component in a network device is shown in FIG. 1 and described—only the network devices and components germane to the understanding of the operations and features of an embodiment are shown and described herein.

The system 100 includes at least one server 102. While only one server 102 is shown in FIG. 1, the system 100 may have any number of servers 102. For instance, multiple servers 102 may be present in order to share and/or separately provide certain functions, for purposes of load balancing, efficiency, etc. The server 102 includes one or more processors 104 and one or more storage media having machine-readable instructions stored thereon that are executable by the processor 104. For example, the machine-readable medium can comprise a database or other data structure. For example, a user information database 106 or other type of data structure can store user preference data, user profile information, device capability information, or other user-related information.

The machine-readable instructions can comprise software, application programs, services, modules, or other types of code. In an embodiment, the various functional components described herein that support mobile 3D graphical messaging are embodied as machine-readable instructions.

In an embodiment, such functional components that reside on the server 102 include an animation engine 108, a transcoding component 110, a 3D graphical messaging application 112a, and other components 114. For the sake of simplicity, the 3D graphical application 112 is described in the context of a messaging application hereinafter—other types of 3D graphical communication applications can be provided, based on the particular implementation to be used, which can provide functionality similar to those described for the 3D graphical application for messaging. Each of these components of the server 102 is described in detail next.

An embodiment of the animation engine 108 provides animation to a 3D graphical representation, such as a 3D avatar, 3D background scenery, or any other content that can be represented in the 3D world. The 3D graphical representation can comprise a template, such as a 3D image of a person's face having hair, eyes, ears, nose, mouth, lips, etc.; a 3D image of mountains, clouds, rain, sun, etc.; a 3D image of a mythical world or fictional setting; or a template of any other kind of 3D content. An animation sequence generated by the animation engine 108 provides the animation (which may include the accompanying audio) to move or otherwise drive the lips, eyes, mouth, etc. of the 3D template for a 3D avatar, thereby providing a realistic appearance of a live speaking person conveying a message. As another example, the animation sequence can drive the movement and sound of rain, birds, tree leaves, etc. in a 3D background scene, which may or may not have any accompanying 3D avatar representation of an individual. In an embodiment, the server 102 provides the animation engine 108 for user devices that do not separately have their own capability to animate their own 3D graphical representations.

An embodiment of the transcoding component 110 transforms animated 3D graphical messages to a form that is suitable for a recipient device. The form suitable for the recipient device can be based on device capability information and/or user preference information stored in the user information database 106. For example, a recipient device may not have the processing power or other capability to present an animated 3D graphical message, and therefore, the transcoding component can transform the animated 3D graphical message from the sender device into a text message or other message form that can be presented by the recipient device that is different in form than an animated 3D graphical message.

In an embodiment, the transcoding component 110 can also transform the animated 3D graphical message into a form suitable for the recipient device based at least in part on some communication channel condition. For instance, high traffic volume may dictate that the recipient device receives a text message in lieu of an animated 3D graphical animation, since a smaller text file may be faster to send than an animated graphic file.

As another example, the transcoding component 110 can also transform or otherwise adjust individual characteristics within an animated 3D graphical message itself. For instance, the size or resolution of a particular object in the animated 3D graphical message (such as a 3D image of a person, tree, etc.) can be reduced, so as to optimize transmission and/or playback during conditions when network traffic may be heavy. The file size and/or bit rate may be reduced by reducing the size or resolution of that individual object.

An embodiment of the server 102 can include the 3D graphical messaging application 112a for use by user devices that do not separately have this application locally installed. That is, an embodiment of the 3D graphical messaging application 112a provide authoring tools to create and/or select 3D graphical representations from a library, and further provides authoring tools to allow the user to remotely create a voice/text message that will be used for animating the graphical representation, if such authoring tools are not otherwise available at the sender device and/or if the user at the sender devices wishes to use the remote 3D graphical messaging application 112a available at the server 102. Further details of embodiments of the 3D graphical messaging application 112 at the server and/or at a user device will be described later below.

The other components 114 can comprise any other type of component to support operation of the server 102 with respect to facilitating mobile 3D graphical messaging. For example, one of the components 114 can comprise a dynamic bandwidth adaptation (DBA) module, such as disclosed in U.S. patent application Ser. No. 10/452,035, entitled “METHOD AND APPARATUS FOR DYNAMIC BANDWIDTH ADAPTATION,” filed May 30, 2003, assigned to the same assignee as the present application, and incorporated herein by reference in its entirety. The DBA module of an embodiment can monitor communication channel conditions, for example, and instruct the transcoding component 110 to dynamically make changes in bit rate, frame rate, resolution, etc. of the signal being sent to a recipient device so as to provide the most optimum signal to the recipient device. As explained above, DBA can be used to make adjustments associated with the overall animated 3D graphical message and/or adjustments with any individual object present therein.

In another embodiment, one of the components 114 can comprise a media customization system, such as disclosed in U.S. Provisional Patent Application Ser. No. 60/693,381, entitled “APPARATUS, SYSTEM, METHOD, AND ARTICLE OF MANUFACTURE FOR AUTOMATIC CONTEXT-BASED MEDIA TRANSFORMATION AND GENERATION,” filed Jun. 23, 2005, assigned to the same assignee as the present application, and incorporated herein by reference in its entirety. The disclosed media customization system can be used by an embodiment of the system 100 to provide in-context supplemental information to accompany animated 3D graphical messages.

In one embodiment, the media customization system can be used to generate or select graphical components that are in context with the content to be transformed into animated 3D graphical content. For example, text or speech inputs of a weather report can be examined to determine graphical representations of clouds, sun, rain etc. that can be used for an animated 3D graphical presentation on the weather (e.g., trees blowing in the wind, rain drops falling, etc.).

In the embodiment of FIG. 1, the server 102 is communicatively coupled to one or more sender devices 116 and one or more recipient devices 118, via a communication network 120. The sender device 116 and the recipient device 118 can communicate with one another (including communication of animated 3D graphical messages) by way of the server 102 and communication network 120. In an embodiment, either or both the sender device 116 and the recipient device 118 can comprise wireless devices that can send and receive animated 3D graphical messages. In embodiments where one of these user devices does not have the capability or the preference to present animated 3D graphical messages, the server 102 can transform an animated 3D graphical message into a form that is more suitable for that user device.

In an embodiment, some of these user devices need not necessarily be wireless devices. For example, one of these user devices can comprise a desktop PC that has capability to generate, send, receive, and playback animated 3D graphical messages, via a hardwire, wireless, or hybrid communication network. Various types of user devices can be used in the system 100, including without limitation, cellular telephones, PDAs, portable laptops, Blackberries, and so forth.

An embodiment of the sender device 116 includes a 3D graphical messaging application 112b, similar to the 3D graphical messaging application 112a residing at the server 102. That is, user devices may be provided with their own locally installed 3D graphical messaging application 112b to create/select 3D graphical representations, generate voice/text messages whose content will be used in an animated 3D presentation, animate the 3D graphical representation, and/or other functions associated with animated 3D graphical messaging. Thus, such animated 3D graphical messaging capabilities may be provided at a user device, alternatively or additionally to the server 102.

The sender device 116 can also include a display 124, such as a display screen to present an animated 3D graphical message. The display 124 can include a rendering engine to present (including animate, if needed) received 3D graphical messages.

The sender device 116 can include an input mechanism 126, such as a keypad, to support operation of the sender device 116. The input mechanism 126 can be used, for example, to create or select 3D graphical representations, to provide user preference information, to control play, rewind, pause, fast forward, etc. animated 3D graphical messages, and so forth.

The sender device 116 can include other components 128. For example, the components 128 can comprise one or more processors and one or more machine-readable storage media having machine-readable instructions stored thereon that are executable by the processor. The 3D graphical messaging application 112b can be embodied as software or other such machine-readable instructions executable by the processor.

An embodiment of the recipient device 118 can comprise the same/similar, different, fewer, and/or greater number of components as the sender device 116. For instance, the recipient device 118 may not have a 3D graphical messaging application 112b, and therefore can use the 3D graphical messaging application 112a residing at the server 102. As another example, the recipient device 118 may not have capability to render or otherwise present animated 3D graphical messages, and therefore may utilize the transcoding component 110 of the server 102 to transform an animated 3D graphical message from the sender device 116 into a more suitable form. Nevertheless, regardless of the particular capabilities of the devices 116 and 118, an embodiment allows such devices to communicate with one another, with the server 102, and/or with a content provider 122.

In one embodiment, the sender device 116 (as well as any other user device in the system 100 that has sufficient capabilities) can post an animated 3D graphical representation to a website blog, portal, bulletin board, discussion forum, on-demand location, or other network location hosted on a network device 130 that can be accessed by a plurality of users. For example, the user at the sender device 116 may wish to express his opinions on politics in an animated 3D graphical message form. Thus, instead of creating the message for presentation at the recipient device 118 as explained above, the sender device 116 can create the message so that the message is accessible as an animated 3D graphical message from the network device 130.

The network 120 can be any type of network suitable for conveying various types of messages between the sender device 116, the recipient device 118, the server 102, and other network devices. The network 120 can comprise wireless, hardwired, hybrid, or any network combination thereof. The network 120 can also comprise or be coupled to the Internet or to any other type of network, such as a VIP, LAN, VLAN, Intranet, and so forth.

In an embodiment, the server 102 is communicatively coupled to one or more content providers 122. The content providers 122 provide various types of media to the server 102, which the server 102 can subsequently convey to the devices 116 and 118. For example, the content providers 122 can provide media that the server 102 transforms (or leaves substantially as-is) to accompany animated 3D graphical messages as supplemental contextual content.

As another example, the content provider 122 (and/or the server 122 in cooperation with the content provider 122) can provide information to the devices 116 and 118 on a subscription basis. For instance, the sender device 116 may subscribe to the content provider 122 to receive sports information, such as up-to-the-minute scores, schedules, player profiles, etc. In such a situation, an embodiment provides the capability for the sender device 116 to receive this information in an animated 3D graphical message form, such as an animated 3D avatar representation of a favorite sportscaster speaking/telling halftime football scores, as an animated 3D graphical representation of a rotating scoreboard, or as any other type of animated 3D graphical representation specified by the subscribing user. Further details of such an embodiment will be described later below.

In yet another example, the content provider 122 can be in the form of an online service provider (such as a dating service) or other type of entity that provides services and/or applications for users. In such an embodiment, various users may have different types of client devices, including desktop and portable/wireless devices. It is even possible for a particular individual user to have a wireless device to receive voicemail messages, a desktop device to receive email or other online content, and various other devices to receive content and to use applications based on the specific preferences of the user.

Accordingly, an embodiment allows the various users and their devices to receive animated 3D graphical content and/or to receive content that is different in form from an original 3D graphical form. As one example, two users may communicate with each other using a dating service available from the content provider 122 or other entity. The first user may generate a text file having his profile, and a 2D graphical image of himself, and then pass this content to the content provider 122 for communication to potential matches via the server 102. The first user may use a cellular telephone to communicate the text file and a desktop PC to communicate the 2D image.

In an embodiment, the server 102 determines the capabilities and preferences associated with a matching second user. For instance, if the second user is capable and prefers to receive animated 3D graphical content, then the server 102 can transform and animate the content of the first user into an animated 3D graphical presentation using information from the text file, and then communicate the animated 3D graphical presentation to the second user's devices, whether a cellular telephone, PC, or other device of the second user's choosing. Moreover, the second user can specify the form of the content (whether 3D or non-3D) to be received at any of her particular devices.

Moreover according to an embodiment, the first user can also specify a preference as to how the second user may receive the content. For instance, the first user can specify that animated 3D graphical presentations of his profile be presented on a cellular telephone of the second user, while a text version of his profile be presented on a PC of the second user. The first user may further specify the manner in which he prefers to communicate with the server 102, including in a 3D or non-3D format such as text, voice, etc.

In the above and/or other example implementations, the transformation of content from one form to another form can be performed such that the end user experience maintained as best as possible. For example, if the end user's client device is capable of receiving and presenting animated 3D content, then that type of content can be delivered to the client device. If, however, the client device is not capable of receiving/presenting animated 3D content, then the server 102 can transform the content to be delivered into “the next closest thing,” such as video content. If the client device is not capable of receiving or presenting or otherwise using video content, then the server 102 can provide the content in some other form that is suitable, and so forth.

In yet another embodiment, users can interactively change the animated 3D graphical content during presentation. For instance, the sender and/or receiver of content in an online gaming environment can choose to change a characteristic of a 3D graphical component during the middle of a game, such as making a character smaller or larger, or perhaps even removing the 3D aspect of the character or of the entire game. Moreover, the users can specify the type of form of the game (whether 3D or not) for different devices used by the same user.

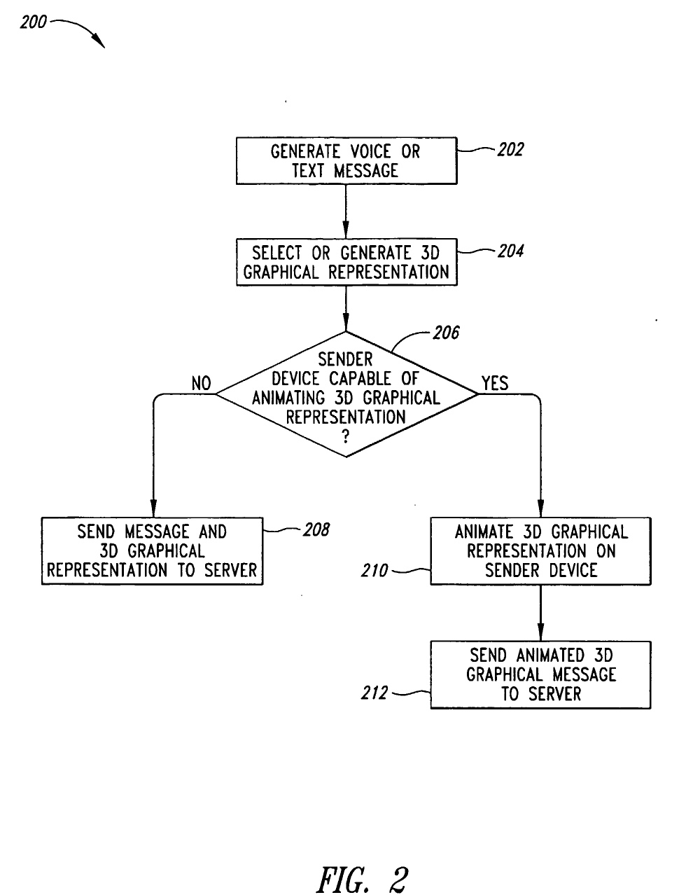

FIGS. 2-4 are flowcharts illustrating operations of an embodiment as such operations pertain to animated 3D graphical messaging. It is appreciated that the various operations shown in these figures need not necessarily occur in the exact order shown, and that various operations can be added, removed, modified, or combined in various embodiments. In one example embodiment, at least some of the depicted operations can be implemented as software or other machine-readable instruction stored on a machine-readable medium and executable by a processor. Such processors and machine-readable media may reside at the server 102 and/or at any one of the user devices.

FIG. 2 is a flowchart of a method 200 that can be used at the sender device 116. At a block 202, the user generates a voice, text message, or other type of original message. For instance, a text message may be generated by typing a message using alphanumeric keypads of the input mechanism 16; a voice message may be generated by using a recording microphone of the input mechanism 16; an audiovideo message may be generated using a camera of the input mechanism 126; or other message generation technique may be used. In one embodiment, the one of the other components 128 can include a conversion engine to convert a text message to a voice message, a voice message to a text message, or to otherwise obtain an electronic form of the user's message that can be used to drive a 3D animation.

At a block 204, the user uses the 3D graphical messaging application 112b at the sender device or remotely accesses the 3D graphical messaging application 112a residing at the server 102 to obtain a 3D graphical representation or other 3D template. For example, with the advent of camera-enabled mobile devices, a device with sufficient processing capabilities can capture images and video with said camera and transform them into 3D graphical representations at the block 204. For example, the user could create a 3D avatar representation of himself by capturing his likeliness with the mobile camera and using the 3D graphical messaging application to transform the captured video or still image representation into a 3D graphical representation. Again, a 3D avatar representation of the user is just one example. The 3D avatar representation could be that of any other mythical or real person or thing—the 3D graphical representation need not even be in avatar form, an instead could comprise 3D graphical representation of scenery, surrounding environment, or other objects of the user's choosing.

The user could then distort, personalize, customize, etc. the 3D graphical representation. In another embodiment, the user can select complete pre-constructed 3D graphical representations (and/or select objects of a 3D representation, such as hair, eyes, lips, trees, clouds, etc., for subsequent construction into a complete 3D graphical representation) from a local or remote library, such as at the server 102.

If the capabilities of the sender device 116 are sufficient to provide animation at a block 206, an animated 3D graphical message can be constructed completely on the client device 210, and then sent to the server 102 at a block 212. Otherwise, the client device 116 sends the message and 3D graphical representation to the server 102 at a block 208 to obtain animation. For example, if the 3D graphical messaging application 112b is not resident on the sender device 116, the sender device 116 can instead send a communication (such as an email, for example) to the server 102 that contains the text version of the message, the recipient device 118's coordinates (e.g., phone number or IP number), and a selected 3D graphical representation.

Accordingly with the method 200 of FIG. 2, one embodiment allows the user of the sender device 116 to provide an animated 3D graphical message that mimes the voice message or uses a text message that has been converted to speech using a text-to-speech engine or other suitable conversion engine. The 3D graphical messaging application 112 thus: 1) allows a user to select or create a 3D graphical from a library of pre-authored 3D graphical representations; 2) allows the user to create a traditional voice message or a text message; and then 3) sends the 3D graphical representation and voice/text message to a remote server application that uses the voice/text message to animate the selected 3D graphical representation, or animates the 3D graphical representation locally.

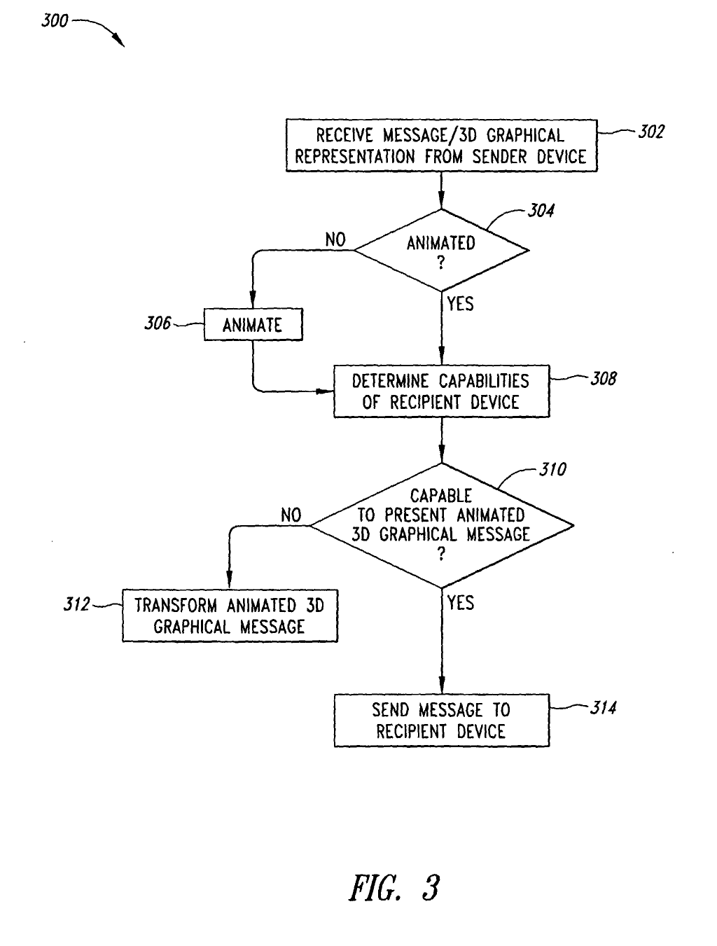

FIG. 3 is a flowchart illustrating a method 300 that can be performed at the server 102. At a block 302, the server 102 receives an animated 3D graphical message from the sender device 116, or receives a message and (non-animated) 3D graphical representation from the sender device 116. If the sender device 116 has not animated the 3D message/graphical as determined at a block 304, then the animation engine 108 of the server 102 provides the animation at a block 306.

The animation at the block 306 can be provided from a speech message received from the sender device 116. Alternatively or additionally, the animation at the block 306 can be provided from a text message converted to a speech message. Other animation message sources can also be used.

If the sender device 116 has provided the animation, the server 102 then determines the capabilities and/or user preferences of the recipient device 118 at blocks 308-310. For example, if the recipient device 118 does not have a 3D graphical messaging application 112b locally installed, the transcoding component 110 of the server 102 can instead transform the animated 3D graphical message into a form appropriate to the capabilities of the recipient device 118 at a block 312. For instance, if the recipient device 118 is a mobile telephone with an application that supports audio and video, then the server 110 can transform the animated 3D graphical message into a 2D video with an audio message to be delivered to the recipient device 118 at a block 314. This is just one example of transformation that can be performed in order to provide a message form that is suitable for the recipient device 118, so that the message can be received and/or presented by the recipient device 118.

If the recipient device 118 does support animated 3D graphical messages, the animated 3D message that is created at the block 306 or that was received from the sender device 116 is sent to the recipient device 118 at the block 314. Supplemental content can also be sent to the recipient device 118 at the block 314. For example, if the animated 3D graphical message pertains to getting together for an upcoming football game, the supplemental content could include weather forecasts for the day of the game.

Sending the animated 3D graphical message to the recipient device at the block 314 can be performed in a number of ways. In one embodiment, the animated 3D graphical message can be delivered in the form of a downloadable file, such as a 3D graphical file or a compressed video file. In another embodiment, the animated 3D graphical message can be delivered by streaming, such as by streaming streamable 3D content or compressed video frames to the recipient device 118.

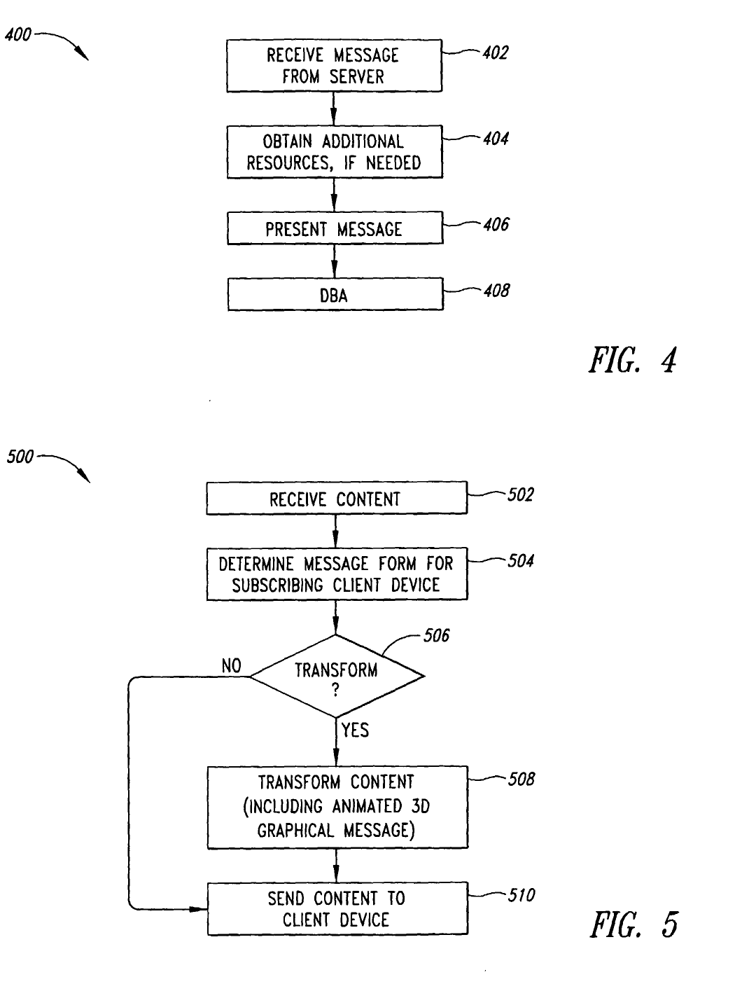

FIG. 4 is a flowchart of a method 400 performed at the recipient device 118 to present a message (whether an animated 3D graphical message and/or a message transformed therefrom). At a block 402, the recipient device 118 receives the message from the server 102 (or from some other network device communicatively coupled to the server 102).

If the recipient device 118 needs to access or otherwise obtain additional resources to present the message, then the recipient device 118 obtains such resources at a block 404. For instance, the recipient device 118 may download a player, application program, supporting graphics and text, or other content from the Internet or other network source, if the server 102 did not otherwise determine that the recipient device 118 needed such additional resource(s) to present or enhance presentation of the message. In general, the recipient device 118 may not need to obtain such additional resources if the device capability information stored at the server 102 is complete and accurate, and since the server 102 transforms the message to a form that is suitable for presentation at the recipient device 118.

At a block 406, the message is presented by the recipient device 118. If the message is an animated 3D graphical message, then the message is visually presented on a display of the recipient device 118, accompanied by the appropriate audio. If the user so desires, the animated message may also be accompanied by a text version of the message, such as a type of “close-captioning” so that the user can read the message, as well as listening to the message from the animated graphical.

As explained above, the presentation at the block 406 can comprise a playback of downloaded file. In another embodiment, the presentation can be in the form of a streaming presentation.

At a block 408, the recipient device 118 can send device data (such as data pertaining to dynamically changing characteristics of its capabilities, such as power level, processing capacity, etc.) and/or data indicative of channel conditions to the server 102. In response to this data, the server 102 can perform a DBA adjustment to ensure that the message being presented by the recipient device 118 is optimum.

In one embodiment, adjustment can involve changing characteristics of the animated 3D graphical content being provided, such as changing an overall resolution of the entire content, or changing a resolution of just an individual component within the 3D graphical content. In another embodiment, adjustment can involve switching from one output file to a different output file (e.g., pre-rendered files) from the server 102. For instance, the same content can be embodied in different animated 3D graphical content files (having different resolutions, bit rates, color formats, etc. for instance) or perhaps even embodied in forms other than animated 3D graphical form. Based on the adjustment that is required, the server 102 and/or the recipient client device 118 can select to switch from a current output file to a different output file, seamlessly.

Various embodiments are described herein with specific references as to the type of message (whether animated 3D graphical message, non-animated messages such as voice or text, non-3D messages such a 2D messages, etc) and the network device where such messages are generated or otherwise processed. It is appreciated that these descriptions are merely illustrative.

For instance, it is possible for the sender device 116 to generate a text or voice message, and then provide the text or voice message to the server 102—the original message provided by the sender device 116 need not be graphical in nature. The server 102 may determine that the recipient device 118 has the capability to animate the message and to also provide its own 3D graphical. Therefore, the server 102 can convey the text or voice message to the recipient device 118, and then the recipient device 118 can animate a desired 3D graphical based on the received message.

FIG. 5 is a flowchart of a method 500 to provide animated 3D graphical messages to client devices, such as the sender device 116 and/or the recipient device 118, based on a subscription model. In particular, an embodiment of the method 500 involves a technique to provide content from the content providers 122 to client devices in an animated 3D graphical message form and/or in a form suitable for the client devices, based on device capabilities, channel conditions, and/or user preferences.

At a block 502, the server 102 receives content from the content providers 122. Examples of content include, but are not limited to, audio, video, 3D renders, animation, text feeds such as stock quotes, news and weather broadcasts, satellite images, and sports feeds, Internet content, games, entertainment, advertisement, or any other type of multimedia content.

One or more client devices, such as the sender device 116 and/or the recipient device 118, may have subscribed to receive this content. Moreover, the subscribing client device may have provided information to the server 102 as to how it prefers to receive this content, device capabilities, and other information. For instance, the client device can provide information as to whether it has the capability and/or preference to receive the content in the form of an animated 3D graphical message. An implementation of such a message can comprise, for example, an animated 3D graphical image of a favorite sportscaster or other individual presenting scores of a football game.

At a block 504, the server 102 determines the message form for the subscribing client device, and can also confirm the subscription status of the client device. In one embodiment, this determination at the block 504 can involve accessing data stored in the user information database 106. Alternatively or additionally, the client device can be queried for this information.

Determining the message form can include, for example, examining parameters for a message that has been provided by the subscribing user. The user may have customized a particular 3D template to use for presenting the content, in such a manner that the user can receive the content in the form, time, and other condition specified by the user.

If the client device has no special preferences or requirements for transformation, as determined at a block 506, then the content is sent to the client device at a block 510 by the server 102. If, on the other hand, the client device does have special preferences or requirements for the content, then the content is transformed at a block 508 prior to being sent to the client device at the block 510.

For example, the client device might specify that it wishes to receive all textual content in the form of an animated 3D graphical message. Therefore, the server 102 can convert the textual content to speech, and then drive the animation of a desired 3D graphical representation using the speech.

As another example, the client device may wish to receive textual content in the form of an animated 3D graphical message, while other types of content need not be delivered in animated 3D form. Accordingly, it is possible in an embodiment to provide messages and other content to client devices in mixed forms, wherein a particular single client device can receive content in different forms and/or multiple different client devices operated by the same (or different) users can receive content in respective different forms.

Of course, it is to be appreciated that the above animation and transformation need not necessarily be performed at the server 102. As previously described above, client devices having sufficiently capability can perform animation, transformation, or other related operations alternatively or additionally to having such operations performed at the server 102.

In an embodiment that can be supported by the features and functions described above, certain types of media files can provide animated 3D graphical content that is derived from input data that may not necessarily be visual in nature. Examples of such files include but are not limited to Third Generation Partnership Project (3GPP) files.

For instance, the input data may be in the form of text that provides a weather forecast. An embodiment examines the input text, such as by parsing individual words, and associates the parsed words with graphical content, such as graphical representations of clouds, rain, wind, weatherman, a person standing with an umbrella, etc. At least some of this graphical content may be in the form of 3D graphical representations. Next, image frames that depict movement of the graphical content (whether the entire graphical piece, or a portion thereof such as lips) from one frame to another are generated, thereby providing animation.

The frames are assembled together to form an animated 3D graphical presentation and encoded into a 3GPP file or other type of media file. The media file is then delivered to a user device that is capable to receive and present the file, and/or that has preferences in favor of receiving such types of files, such as by download or streaming.

Various embodiments can employ several techniques to create and animate 3D graphical representations. Examples of these techniques are disclosed in U.S. Pat. Nos. 6,876,364 and 6,853,379. Moreover, various embodiments usable with wireless user devices can employ systems and user interfaces to facilitate or otherwise enhance the communication of animated 3D graphical content. Examples are disclosed in U.S. Pat. No. 6,948,131. All of these patents are owned by the same assignee as the present application, and are incorporated herein by reference in their entireties.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

Although specific embodiments of and examples for the system and method for mobile 3D graphical communication are described herein for illustrative purposes, various equivalent modifications can be made without departing from the spirit and scope of the invention, as will be recognized by those skilled in the relevant art after reviewing the specification. The various embodiments described above can be combined to provide further embodiments. Aspects of the embodiments can be modified, if necessary, to employ systems, circuits and concepts of the various patents, applications and publications owned by the assignee of the present application (and/or by others) to provide yet further embodiments.

For example, software or other machine-readable instruction stored on a machine-readable medium can implement at least some of the features described herein. Such machine-readable media can be present at the sender device, receiver device, server or other network location, or any suitable combination thereof.

These and other changes can be made to the embodiments in light of the above-detailed description. In general, in the following claims, the terms used should not be construed to limit the invention to the specific embodiments disclosed in the specification, Abstract, and the claims. Accordingly, the invention is not limited by the disclosure, but instead its scope is to be determined entirely by the following claims, which are to be construed in accordance with established doctrines of patent claim interpretation.

1. A method comprising:
obtaining, by a computing environment, non-visual input content;
associating, by the computing environment, at least some of the input content to graphical representations that can be used for a three-dimensional (3D) graphical presentation;
animating, by the computing environment, the 3D graphical presentation based at least in part on the input content;
placing, by the computing environment, the animated 3D graphical presentation into a media file; and
delivering, by the computing environment, the media file to at least one client device.

2. The method of claim 1, wherein the media file comprises a 3rd Generation Partnership Project (3GPP) file for wireless devices.

3. The method of claim 1 wherein delivering the media file includes delivering the media file by download or by streaming.

4. A method comprising:
obtaining, by a computing environment, an original message;
obtaining, by the environment, a three-dimensional (3D) graphical representation;
determining, by the computing environment, whether a recipient device is suitable for an animated 3D graphical message derived from the original message and from the 3D graphical representation;
if the recipient device is determined to be suitable for the animated 3D graphical message, generating, by the computing environment, the animated 3D graphical message and delivering same to the recipient device; and
if the recipient device is determined to be unsuitable for the animated 3D graphical message, instead generating, by the computing environment, some other type of message that is derived from the original message and delivering same to the recipient device.

5. The method of claim 4 wherein delivering the animated 3D graphical message or the other type of message includes wirelessly delivering the message to the recipient device.

6. The method of claim 4 wherein generating the animated 3D graphical message includes generating an animated 3D avatar that represents person, based at least in part on movement of objects of the 3D graphical representation, that conveys contents of the original message through animation of the 3D avatar.

7. The method of claim 6 wherein the animated 3D avatar that represents a person comprises an animated 3D avatar that represents a user of a sender device that provided the original message.

8. The method of claim 6 wherein the animated 3D avatar that represents a person comprises an animated 3D avatar that represents a being different than a user of a sender device that provided the original message.

9. The method of claim 4 wherein obtaining the 3D graphical representation includes obtaining 3D graphical representations of objects that do not represent beings.

10. The method of claim 4 wherein obtaining the original message includes obtaining a non-graphical message from a sender device, the method further including transforming at least a portion of the non-graphical message into speech content that can be used in conjunction with the animated 3D graphical message.

11. The method of claim 4 wherein generating the animated 3D graphical message includes receiving the animated 3D graphical message from a sender device that has capability to generate animation.

12. The method of claim 11 wherein generating some other type of message includes transforming the animated 3D graphical message to a message form that can be presented by the recipient device.

13. The method of claim 4 wherein generating some other type of message comprises generating a text, voice, video, or 2D image message.

14. The method of claim 4 wherein obtaining the original message includes obtaining a text, voice, video, or 2D image message from a sender device.

15. The method of claim 4 wherein obtaining the 3D graphical representation includes selecting the 3D representation from a plurality of 3D representations stored in a library.

16. The method of claim 4 wherein obtaining the 3D graphical representation includes building the 3D representation from a plurality selectable image objects stored in a library.

17. The method of claim 4, further comprising:
receiving content from a content provider;
determining whether the recipient device is a subscriber to receive the content;
determining parameters for delivering the content to the recipient device, if determined to be a subscriber, including identifying user-specified preferences that affect delivery and presentation of the content;
transforming the received content into an animated 3D graphical message and delivering same to the recipient device, if the determined parameters specify that the recipient device should receive the content in animated 3D graphical message form; and
delivering the received content to the recipient device in a message form different from the animated 3D graphical message form, if the determined parameters specify that the recipient device should not receive the content in the animated 3D graphical message form.

18. The method of claim 4, further comprising delivering the animated 3D graphical message to a network location so as to be made accessible to a plurality of recipient devices.

19. The method of claim 18 wherein delivering the animated 3D graphical message to the network location includes delivering the animated 3D graphical message to any one or more of a blog, website, portal, bulletin board, forum, and on-demand location.

20. The method of claim 4 wherein delivering the animated 3D graphical message comprises streaming the animated 3D graphical message.

21. The method of claim 4 wherein delivering the animated 3D graphical message comprises providing the animated 3D graphical message to the recipient device via file download.

22. A system of one or more computing devices comprising:
at least one processor; and
logic coupled, to the at least one processor and adapted to
obtain input content;
generate a three-dimensional (3D) graphical representation;
determine whether a recipient device is suitable for an animated 3D graphical presentation derived from the input content and from the 3D graphical representation;
generate the animated 3D graphical presentation and for delivering same to the recipient device, if the recipient device is determined to be suitable for the animated 3D graphical presentation; and
generate some other type of presentation that is derived from the input content and for delivering same to the recipient device, if the recipient device is determined to be unsuitable for the animated 3D graphical presentation.

23. The system of claim 22, wherein the logic is further adapted to transform the animated 3D graphical presentation to a different presentation form that can be delivered to the recipient device.

24. The system of claim 22 wherein the logic is further adapted to generate the 3D graphical representation, and said generating comprises storing selectable 3D graphical representations, or portions of 3D graphical representations that can be assembled together.

25. The system of claim 22, wherein the logic is further adapted to:
receive information from a provider;
determine whether the recipient device is a subscriber to receive the information;
determine parameters for delivering the information to the recipient device, if determined to be a subscriber, including means for identifying user-specified preferences that customize delivery and presentation of the information;
transform the received information into an animated 3D graphical presentation and delivering same to the recipient device, if the determined parameters specify that the recipient device is suitable for the information in animated 3D graphical presentation form; and
deliver the received information to the recipient device in a presentation form different that the animated 3D graphical presentation form, if the determined parameters specify that the recipient device is unsuitable for the information in the animated 3D graphical presentation form.

26. The system of claim 22, wherein the logic is further adapted to change at least a portion of the 3D graphical presentation in response to a change in a parameter, the parameter including any one or more of a device characteristic, channel condition, user preference, and provider preference, including means for interactive change by users during presentation.

27. The system of claim 22, wherein the logic is further adapted to deliver presentations of different form to respective different devices of a same user.

28. The system of claim 22, wherein the logic is further adapted to allow multiple users to communicate with one another using different devices that can present different presentation forms, including sender devices that can be used to provide 3D graphical content that can be animated and receiver devices that can present the 3D graphical content in a different presentation form.

29. The system of claim 22 wherein the input content is non-graphical content, and the logic is further adapted to examine the non-graphical input content to identify associated in-context graphical content that can be assembled together to provide the animated 3D graphical presentation.

30. The system of claim 22, wherein the logic is further adapted to deliver presentations to recipient devices in a manner that substantially maintains end user experience, including as changing delivery from the 3D graphical presentation to a video presentation.

31. The system of claim 22, wherein the logic is further adapted to leverage the system with existing applications provided by other entities.

32-37. (canceled)

38. An article of manufacture, comprising:
a machine-readable medium; and
a plurality of programming instructions stored on the storage medium and configured to program an apparatus to:
obtain input content;
provide a three dimensional (3D) graphical representation;
determine whether a recipient device is suitable for an animated 3D graphical presentation derived from the input content and from the 3D graphical representation;
generate the animated 3D graphical presentation and deliver the animated 3D graphical presentation to the recipient device, if the recipient device is determined to be suitable for the animated 3D graphical presentation; and
alternatively generate some other type of presentation that is derived from the input content and deliver the other type of presentation to the recipient device, if the recipient device is determined to be unsuitable for the animated 3D graphical presentation.

39. The article of manufacture of claim 38 wherein the machine-readable medium is resident on a wireless sender device.

40. The article of manufacture of claim 38 wherein the machine-readable medium is resident on a server that can communicate with the recipient device.

41. The article of manufacture of claim 38 wherein the plurality of programming instructions are further configured to program an apparatus to transform the animated 3D graphical presentation to a different presentation form that can be presented by the recipient device.

42. The article of manufacture of claim 38 wherein plurality of programming instructions are further configured to program an apparatus to transform the input content into a form that can be used by the animated 3D graphical presentation.

43. The article of manufacture of claim 38 wherein the plurality of programming instructions are further configured to program an apparatus to transform subscription content into a presentation form that can be presented by the recipient device, including animated 3D graphical presentation that can convey the subscription content.

44. The article of manufacture of claim 38 wherein the plurality of programming instructions are further configured to program an apparatus to provide the animated 3D graphical presentation to a network location that can be accessed by a plurality of client devices.

45. The article of manufacture of claim 38 wherein the plurality of programming instructions are further configured to program an apparatus to said deliver the animated 3D graphical presentation and said deliver includes delivering by way of file download or streaming.

46. The article of manufacture of claim 38 wherein the plurality of programming instructions are further configured to program an apparatus to provide the input content in 3D format and to transform the input content in 3D format to a non-3D format to be delivered to the recipient device.

47. The article of manufacture of claim 38 wherein the plurality of programming instructions are further configured to program an apparatus to change a characteristic of an object contained within the animated 3D graphical presentation in response to a change in user preference, channel condition, or a characteristic of the recipient device.

48. The article of manufacture of claim 38 wherein the plurality of programming instructions are further configured to program an apparatus to send a different media file having the changed characteristic, or to modify the characteristic in the presentation itself that is being delivered.

49. The article of manufacture of claim 38 wherein the machine-readable medium can be leveraged with existing products, services, and applications of third parties that use a communication network in which the apparatus participates.

50. The article of manufacture of claim 38 wherein the animated 3D presentation can comprise a portion of any one or more of a message, online posting, game, online service content, update, entertainment presentation, advertisement, news, or multimedia content.

51. The article of manufacture of claim 38 wherein at least some portion of the animated 3D graphical presentation has 3D form and another portion of the presentation has a non-3D form.
